(19) United States
(12) Patent Application Publication
(10) Pub. No.: US 2014/0157788 A1
(43) Pub. Date: Jun. 12, 2014

(54) FUEL NOZZLE FOR GAS TURBINE

(71) Applicant: GENERAL ELECTRIC COMPANY, Schenectady, NY (US)

(72) Inventor: Mahesh Bathina, Bangalore (IN)

(73) Assignee: GENERAL ELECTRIC COMPANY, Schenectady, NY (US)

(21) Appl. No.: 13/707,550

(22) Filed: Dec. 6, 2012

(51) Int. Cl. F02C 7/22

(52) U.S. Cl. CPC F02C 7/22
USPC 60/776; 60/740; 60/737

(57) ABSTRACT

A gas turbine system includes a fuel nozzle. The fuel nozzle has a first wall extending along an axis and defines a first fluid passage. A second wall surrounds the first wall and defines a second fluid passage. A third wall surrounds the second wall and defines a third fluid passage. The first and second fluid passages are configured to collectively direct a flow of air and fuel into a combustion region to produce a flame. The third fluid passage is configured to direct a diluent into the combustion region to adjust a combustion parameter of the flame.

### BACKGROUND OF THE INVENTION

The subject matter disclosed herein relates to gas turbines, and more specifically, to systems and methods for controlling flame stability.

Gas turbine systems generally include a compressor, a combustor, and a turbine. The compressor compresses air from an air intake, and subsequently directs the compressed air to the combustor. In the combustor, the compressed air received from the compressor is mixed with a fuel and is combusted to create combustion gases. The combustion gases are directed into the turbine. In the turbine, the combustion gases pass across turbine blades of the turbine, thereby driving the turbine blades, and a shaft to which the turbine blades are attached, into rotation. The rotation of the shaft may further drive a load, such as an electrical generator, that is coupled to the shaft.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In one embodiment, a method includes receiving air, fuel, and a diluent in respective air and fuel conduits within a fuel nozzle of a gas turbine system. The method includes directing a mixture of the air and the fuel into a combustion region to produce a flame, and directing the diluent into the combustion region to adjust at least one combustion parameter of the flame.

In a second embodiment, a gas turbine system includes a fuel nozzle. The fuel nozzle includes a first well extending along an axis and defining a first fluid passage. A second wall surrounds the first wall and defines a second fluid passage. A third wall surrounds the second wall and defines a third fluid passage. The first and second fluid passages are configured to collectively direct a flow of air and fuel into a combustion region to produce a flame. The third fluid passage is configured to direct a diluent into the combustion region to adjust a combustion parameter of the flame.

In a third embodiment, a gas turbine system includes a at least one fuel nozzle configured to receive and mix the air with a fuel and a combustor configured to combust a mixture of the air and the fuel into combustion products. The at least one fuel nozzle includes a first wall extending along an axis and defining a first fluid passage, a second wall surrounding the first wall and defining a second fluid passage, and a third wall surrounding the second wall and defining a third fluid passage. The first and second fluid passages are configured to collectively flow the air and the fuel into the combustor to produce a flame. The third fluid passage is configured to direct a diluent into the combustor around the air and the fuel to adjust a combustion parameter of the flame.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic diagram of an embodiment of a gas turbine system having a fuel nozzle with a separate diluent conduit to improve flame stability;

FIG. 2 is a perspective view of an embodiment of the fuel nozzles of FIG. 1, illustrating an arrangement of the fuel nozzles within a combustor of the gas turbine system;

FIG. 3 is a block diagram of an embodiment of a fuel supply system configured to provide a fuel and a diluent to respective fuel and diluent conduits of the fuel nozzles of FIG. 1;

FIG. 4 is a schematic diagram of an embodiment of the fuel nozzle of FIG. 1 having a separate diluent conduit, illustrating a plurality of premixing tubes to mix air and fuel to produce a flame;

FIG. 5 is a schematic diagram of an embodiment of the fuel nozzle of FIG. 1 having a separate diluent conduit, illustrating a plurality of swirl vanes to mix air and fuel; and

FIG. 6 is a perspective view of an embodiment of the swirl vane of FIG. 5.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is directed toward systems and methods to improve flame stability within combustors of gas turbine systems. Typically, a fuel nozzle receives, mixes, and combusts fuel and air, thereby producing a flame. Unfortunately, the flame may be subjected to pressure pulsations and other flame dynamics, which may decrease the efficiency of the gas turbine system. Thus, it is now recognized that undesired flame dynamics may be reduced by modifying the flame location, volume, length, and other combustion parameters of the flame. In a presently contemplated embodiment, a fuel nozzle includes a separate diluent conduit which delivers a diluent (e.g., a non-combustible fluid such as steam, carbon dioxide, or nitrogen) surrounding the flame in order to modify the combustion parameters of the flame. More specifically, the diluent changes the shape and location of the flame by reducing the availability and/or reactivity of the combustible fluids in certain regions of the fuel nozzle. The diluent may also act as a heat sink, thereby abating or delaying the heat release of combustion, which may also reduce the flame dynamics.

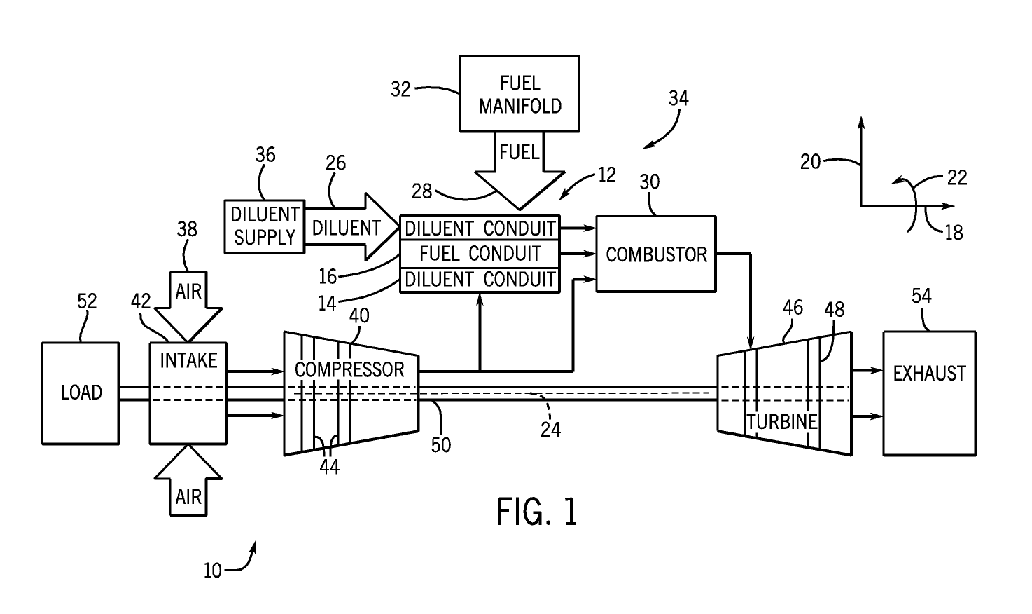

Turning now to the figures, FIG. 1 illustrates a block diagram of an embodiment of a gas turbine system 10 having a fuel nozzle 12 with a separate diluent conduit 14 and a separate fuel conduit 16 to improve flame stability within the gas turbine system 10. Throughout the discussion, a set of axes will be referenced. These axes are based on a cylindrical coordinate system and point in an axial direction 18, a radial direction 20, and a circumferential direction 22. For example, the axial direction 18 extends along a longitudinal axis 24 of the gas turbine system 10, the radial direction 20 extends away from the longitudinal axis 24, and the circumferential direction 22 extends around the longitudinal axis 24.

As shown, the diluent and fuel conduits 14 and 16 route respective flows of diluent 26 and fuel 28 into a combustor 30. Notably, the diluent conduit 14 is separate from the fuel conduit 16, which enables the flow of the diluent 26 to be monitored and controlled independently of the flow of the fuel 28. As noted earlier, the diluent 26 may be a non-combustible fluid (e.g., steam or nitrogen) that changes the shape of the combustion flame, a heat sink fluid (e.g., cold air or cold fuel) that reduces or delays the spatial volumetric heat released by the flame, or any combination thereof. In certain embodiments, the composition of the diluent 26 may be adjusted based on certain combustion instabilities associated with operating conditions of the gas turbine system 10 and may vary during the different modes of operation (e.g., start-up or steady-state operation). For example, during start-up of the gas turbine system 10, it may be desirable to purge the combustor 30 using the diluent 26 (e.g., steam) before introducing the fuel 28 to the combustor 30.

The fuel 28 may include a mixture of several components, such as primary fuels (e.g., methane) and fuel additives (e.g., higher hydrocarbons (HHCs) having more carbon atoms than the primary fuel). In certain embodiments, the fuel 28 may also include varying amounts of the diluent 26. That is, the diluent 26 may be supplied to the fuel conduit 16 as well as the diluent conduit 14. As the composition of the fuel 28 generally affects the stability of the flame within the combustor 30, it may be desirable to also control the composition of the fuel 28 (e.g., based on combustion instabilities coupled with operating conditions of the gas turbine system 10, such as flows, temperatures, pressures, combustion dynamics, flame measurements, exhaust composition, or speeds) in order to improve the flame stability. Furthermore, the material supplied to the fuel conduit 16 and the diluent conduit 14 may vary depending on the combustion instabilities and operating mode of the gas turbine system 10. For example, for high-load conditions, it may be desirable to route the fuel 28 through both the diluent conduit 14 and the fuel conduit 16. In general, the flow, pressure, temperature, and/or composition of the diluent 26 and the fuel 28 may be independently increased or decreased based on the detected operating condition. The control logic may vary among embodiments.

As illustrated, the fuel 28 is supplied to the fuel nozzle 12 by a fuel manifold 32 of a fuel supply system 34. Similarly, the diluent 26 is supplied to the fuel nozzle 12 by a diluent supply 36, which, in certain embodiments, may be included within the fuel supply system 34. The fuel supply system 34 and the diluent supply 36 may include, for example, storage tanks, mobile skids, upstream or downstream systems relative to the gas turbine system 10, or any other suitable source of the fuel 28 and the diluent 26.

The fuel nozzle 12 also receives an oxidant, e.g., air 38, supplied by a compressor 40. That is, the air 38 flows from an air intake 42 into the compressor 40, where the rotation of compressor blades 44 compresses and pressurizes the air 38. Within the fuel nozzle 12, the fuel 28 mixes with the air 38 at a ratio suitable for combustion, emissions, fuel consumption, power output, and the like. Thereafter, the mixture of the fuel 28 and the air 38 is combusted into hot combustion products within the combustor 30. These hot combustion products enter a turbine 46 and force turbine blades 48 to rotate, thereby driving a shaft 50 into rotation. The rotating shaft 50 provides the energy for the compressor 40 to compress the air 38. More specifically, the rotating shaft 50 rotates the compressor blades 44 attached to the shaft 50 within the compressor 40, thereby pressurizing the air 38 that is fed to the combustor 30. In addition, the rotating shaft 50 may drive a load 52, such as an electrical generator or any device capable of utilizing the mechanical energy of the shaft 50. After the turbine 46 extracts useful work from the combustion products, the combustion products are discharged to an exhaust 54.

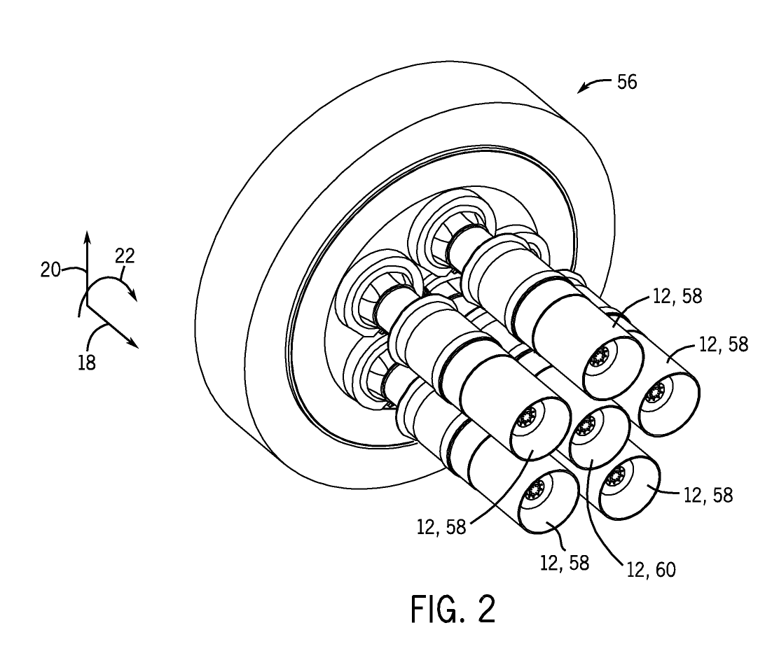

FIG. 2 illustrates an embodiment of the gas turbine system 10 having multiple fuel nozzles 12. As shown, six fuel nozzles 12 are mounted to a head end 56 of the combustor 30. The fuel nozzles 12 are disposed in a concentric arrangement. That is, five fuel nozzles 12 (e.g., outer fuel nozzles 58) are disposed about a central fuel nozzle 60. As will be appreciated, the arrangement of the fuel nozzles 12 about the head end 56 may vary. For example, the fuel nozzles 12 may be disposed in a circular arrangement, a linear arrangement, or in any other suitable arrangement. In addition, the number of fuel nozzles 12 may vary. For example, certain embodiments may of the gas turbine system 10 may include 1, 2, 3, 4, 5, 10, 50, 100, or more fuel nozzles 12.

As explained above, the fuel nozzles 12 may include the separate diluent conduits 14 to reduce flame dynamics within the combustor 30. In certain embodiments, a subset of the fuel nozzles 12 may include the separate diluent conduits 14, while another subset of the fuel nozzles 12 do not. For example, the central fuel nozzle 60 (e.g., pilot fuel nozzle) may generally have a greater influence on flame dynamics, and it may be desirable to equip the central fuel nozzle 60 with the separate diluent conduits 14. In other words, the outer fuel nozzles 58, the central fuel nozzle 60, or any combination thereof, may include the diluent conduits 14 to improve the operability (e.g., flame stability) of the gas turbine system 10.

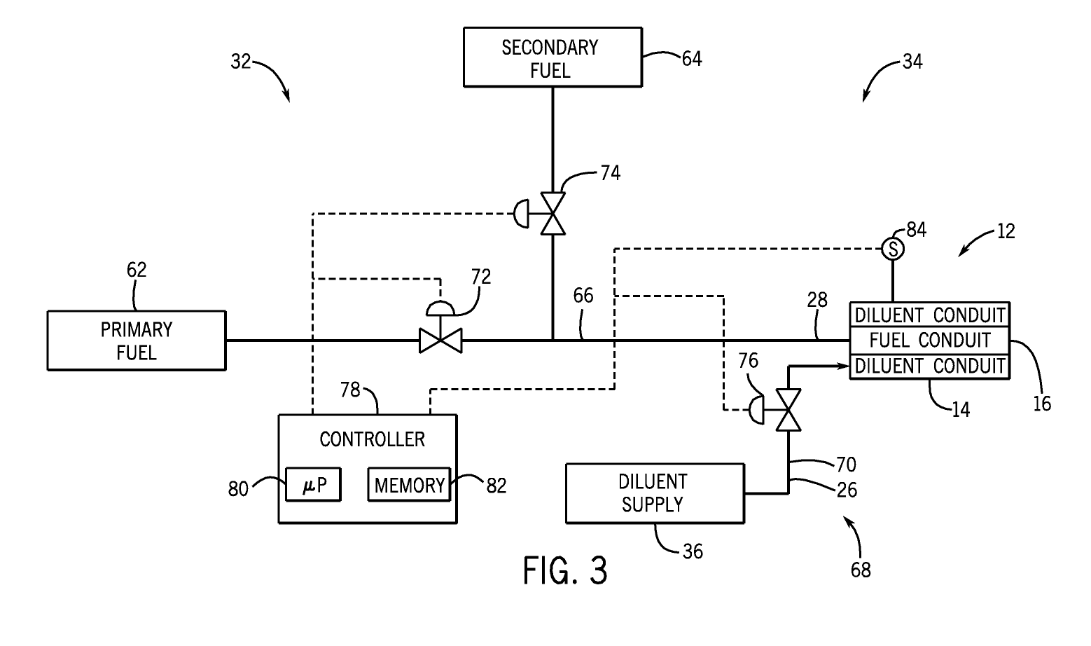

FIG. 3 is an embodiment of the fuel supply system 34 with features to supply the diluent 26 and the fuel 28 into separate conduits 14 and 16 of the fuel nozzle 12 to reduce flame dynamics within the combustor 30. As illustrated, the fuel supply system 34 includes the fuel manifold 32, which in turn includes a primary fuel supply 62 (e.g., methane) and a secondary fuel supply 64 (e.g., one or more HHCs) coupled together by a common pipeline 66. Accordingly, the fuel manifold 32 may direct the primary fuel 62, the secondary fuel 64, or a mixture of the primary and secondary fuels 62 and 64 from the common pipeline 66 into the fuel nozzle 12 (e.g., the fuel conduit 16) during operation of the gas turbine system 10. It should be noted that certain embodiments of the fuel manifold 32 may include one or more diluent supplies (e.g., diluent supply 36) to provide the diluent 26 into the fuel conduit 16. Supplying the diluent 26 along with the fuel 28 may increase the velocity of the fuel 28, which may reduce flame dynamics within the combustor 30. In certain embodiments, the composition of the fuel 28 routed to the fuel conduit 16 may vary depending on an combustion instabilities and operating mode of the gas turbine system 10. More specifically, a ratio of the primary fuel 62 to the secondary fuel 64 may be controlled in order to adjust certain combustion parameters (e.g., flame volume, flame size, net heat release). For example, during start-up operation, it may be desirable to route a fuel with a higher heating value (e.g., a greater ratio of the secondary fuel 62 to the primary fuel) to the fuel conduit 16 to produce a higher-temperature flame.

A diluent manifold 68 includes the diluent supply 36 and a diluent pipeline 70 to provide the diluent 26 to the separate diluent conduit 14 of the fuel nozzle 12. As noted above, the diluent 26 may be a non-combustible fluid (e.g., steam or nitrogen) that changes the shape of the combustion flame, a heat sink (e.g., cold air or cold fuel) that reduces or delays the spatial volumetric heat released by the flame, or a combination thereof. In certain embodiments, the composition of the diluent 26 may be based on combustion instabilities and operating mode of the gas turbine system 10. For example, nitrogen may be used to purge the fuel nozzle 12 during startup, and steam may be used to control the shape of the combustion flame during steady-state operation, or vice versa. In embodiments where the diluent 26 is also directed to the fuel conduit 16, the composition of the diluent 26 may vary between the fuel conduit 16 and the diluent conduit 14. Furthermore, the desired flow rate of the diluent 26 may be based on an operating mode of the gas turbine system 10 (e.g., a start-up mode, a steady-state mode, a transient mode, a partial-load mode, a full-load mode, or a full-speed no load mode). For example, higher flow rates of the diluent 26 may be desired with the higher flow rates of the fuel 28 associated with steady-state operation.

Notably, the diluent pipeline 70 is separate from the common pipeline 66 of the fuel manifold 32. As a result, the respective compositions of the fuel 28 and the diluent 26 may be controlled separately from one another. In other words, the illustrated configuration enables the composition of the fuel 28 to be changed without affecting the composition of the diluent 26, and vice versa. To this end, the fuel supply system 34 includes a plurality of control valves 72, 74, and 76 to respectively adjust the composition and/or flow rates of the fuel 28 and the diluent 26. More specifically, the control valves 72 and 74 may selectively enable, throttle, or block of flows of the primary and secondary fuels 62 and 64, respectively, based on a desired composition and/or flow rate of the fuel 28. In a similar manner, the control valve 76 may adjust the flow rate of the diluent 26 to the fuel nozzle 12.

In order to control the operation of fuel supply system 34, a controller 78 is communicatively coupled to the control valves 72, 74, and 76. The controller includes a processor 80 and memory 82 to execute instructions to adjust the composition and/or flow rate of the fuel 28 and the diluent 26 by adjusting the control valves 72, 74, and 76. These instructions may be encoded in software programs that may be executed by the processor 80. Further, these instructions may be stored in a tangible, non-transitory, computer-readable medium, such as the memory 82. The memory 82 may include, for example, random-access memory, read-only memory, hard drives, and/or the like. In certain embodiments, the controller 78 may execute instructions to control the composition and/or flow rate of the fuel 28 and the diluent 26 based on an operating condition of the gas turbine system 10. Furthermore, the flow rate, velocity, temperature, and/or composition of the diluents 26 may be controlled relative to the flow rates of the air 38 and the fuel 28. For example, it may be desirable to increase, keep constant, or decrease the ratio of the diluents 26 to the air 38 and the fuel 28, depending on the combustion instabilities and operating mode of the gas turbine system 10.

As shown, the controller 78 receives input from a sensor 84. The sensor 84 is coupled to the fuel nozzle 12 and detects operating conditions related to combustion of the fuel 28 and the air 38. For example, the sensor 84 may detect a pressure drop across the fuel nozzle 12, a net heat release within the combustor 30, a flame temperature, a flame length, a flame volume, a flame color, a pressure, any other suitable combustion parameter, or any combination thereof. In certain embodiments, the sensor 84 may detect other parameters related to the gas turbine system 10, such as a rotational speed of the shaft 50 or an energy output of the turbine 46. The controller 78 may execute instructions to control the control valves 72, 74, and 76 based on the parameters detected by the sensor 84. For example, the sensor 84 may detect fluctuations in the flame volume as an indication of flame dynamics. The controller 78 may modify the flow rate of the diluent 26 to the diluent conduit 14 of the fuel nozzle by opening the control valve 76 in order to reduce the flame dynamics. As will be appreciated, the controller 78 may also receive feedback from multiple sensors 84 and control the control valves 72, 74, and 76 based on feedback from multiple sensors 84.

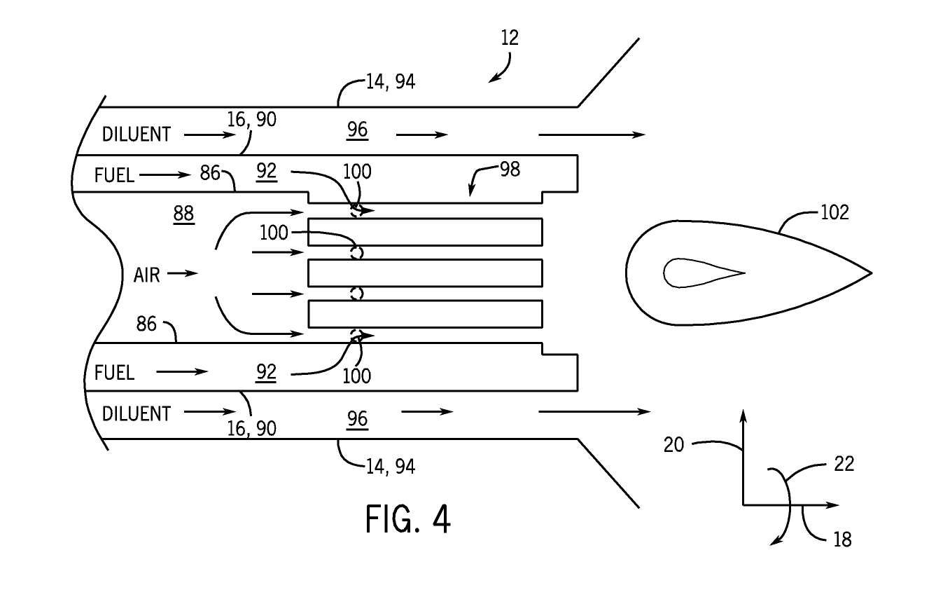

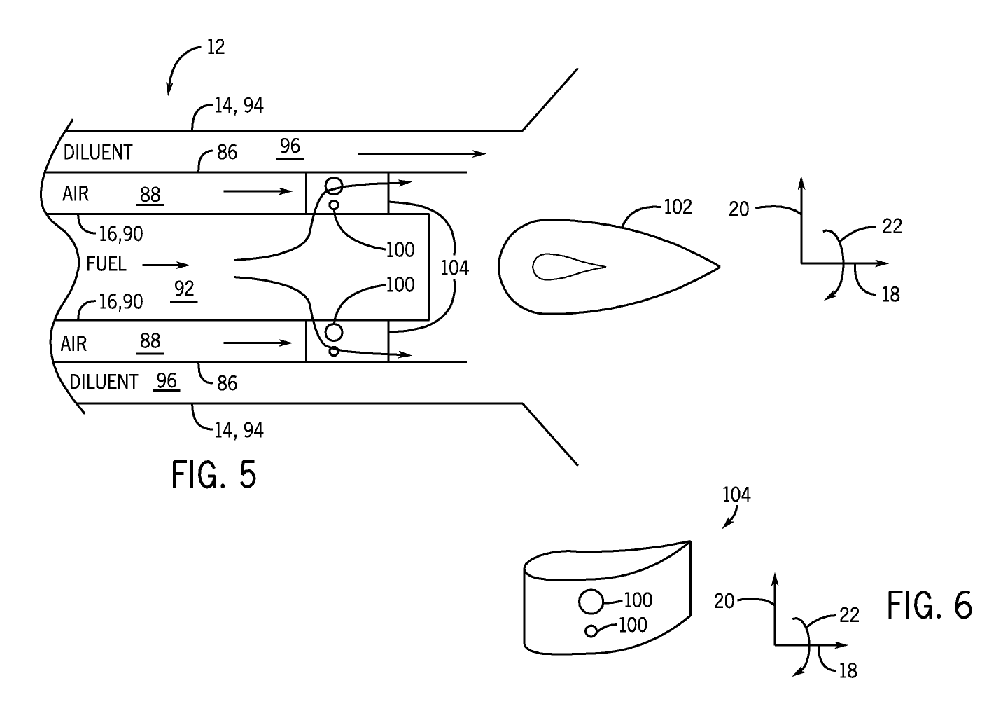

FIGS. 4-6 illustrate various embodiments of the fuel nozzle 12 including the separate diluent and fuel conduits 14 and 16 to improve the operability of the gas turbine system 10. As shown in FIG. 4, the fuel nozzle 12 includes a first wall 86 defining an air passage 88. A second wall 90 surrounds the first wall 86 and defines the fuel conduit 16 and corresponding fuel passage 92. A third wall or shroud 94 surrounds the second wall 90 and defines the diluent conduit 14 and respective diluent passage 96. As illustrated, the diluent passage 96 is the radially 20 outermost passage within the fuel nozzle 12. However, it should be noted that the order of the passages 88, 92, and 96 may vary between embodiments. For example, as shown in FIG. 5, the radially 20 innermost passage may be the fuel passage 92, and the air passage 94 may surround the fuel passage 92. Furthermore, the relative positions of the passages 92, 94, and 96 may vary. For example, the passages 92, 94, 96, may be coaxial, parallel, adjacent, or occupy any other suitable arrangement.

The fuel nozzle 12 of FIG. 4 further includes a plurality of premixing tubes 98 (e.g., 2 to 100, 5 to 200, or 10 to 1000 premixing tubes) to mix the fuel 28 with the air 38. For example, the air 38 may flow axially 18 through the air passage 88 and through the premixing tubes 98. The fuel 28 may enter the premixing tubes 98 radially 20 through one or more premixing orifices 100. After the premixing, the mixture of the air 38 and the fuel 28 is combusted to produce a combustion flame 102. As explained earlier, directing the diluent 26 through the diluent conduit 14 and around the flame 102 may adjust a shape of the flame 102, thereby reducing dynamics and improving the operability of the fuel nozzle 12. For example, increasing an amount of the diluent 26 blanketing the flame 102 may narrow and/or lengthen the flame 102. Similarly, decreasing the flow of the diluents 26 may shorten the flame 102. Accordingly, the shape, length, and/or position of the flame 102 may be controlled by adjusting flow of the diluent 26 around the flame 102. The diluents 26 may also be directed around the mixture of the air 38 and the fuel 28 prior to combustion, which may also control these flame parameters.

FIG. 5 illustrates another embodiment of the fuel nozzle 12 having the separate diluent and fuel conduits 14 and 16 to reduce flame dynamics. More specifically, the fuel nozzle 12 includes the wall 90 defining the fuel passage 92. The wall 86 surrounds the wall 90 and defines the air passage 88, and the third wall 94 surrounds the wall 86 and defines the diluent passage 96. Again, although the diluent passage 96 is illustrated as the radially 20 outermost passage, the relative positions of the passages 92, 94, and 96 may vary in other embodiments.

The fuel nozzle 12 also includes a plurality of swirl vanes 104 to mix the fuel 28 with the air 38. In particular, the air 38 may flow axially 18 within the air passage 88 and across the swirl vanes 104. The fuel 28 flows from the fuel passage 92 through the premixing orifices 100 of the swirl vane 104 and enters the air passage 88 to mix with the air 38. As illustrated more clearly in FIG. 6, the swirl vanes 104 are arcuate along the axial 18 direction, which induces a circumferential 22 swirl to the air 38 flowing across the swirl vane 104. The swirl may improve the uniformity of the mixture of the fuel 28 and the air 38 directed to the combustor 30. In addition, the swirl vane 104 may have an airfoil shape or teardrop shape, as shown. Furthermore, the width of the vane may generally decrease in the downstream or axial 18 direction (e.g., converges towards a trailing edge of the swirl vane 104).

It should be noted that the embodiments of the fuel nozzles 12 and their respective geometries are not intended to be limiting. For example, the passages 88, 92, and 96 may be interchangeable in certain embodiments. Indeed, the disclosed techniques may be applied to a variety of fuel nozzle designs, all of which fall within the scope and spirit of the present disclosure.

Technical effects of the disclosed embodiments include systems and methods to improve flame stability within the combustor 30 of the gas turbine system 10. In particular, the fuel nozzle 12 is equipped with the separate diluent and fuel conduits 14 and 16 to adjust various characteristics of the combustion flame 102. More specifically, the diluent 28 may change the shape and location of the flame 102 by reducing the availability and/or reactivity of the combustible fluids (e.g., the air 38 and the fuel 28) in certain regions of the fuel nozzle 12. Accordingly, the diluent 26 may behave as a heat sink and may abate or delay the heat release of combustion, thereby reducing flame dynamics and improving the efficiency of the gas turbine system 10.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method, comprising:
receiving an oxidant in an oxidant conduit and fuel in a fuel conduit within a fuel nozzle of a gas turbine system;
receiving a diluent in a diluent conduit of the fuel nozzle;
directing a mixture of the oxidant and the fuel into a combustion region to produce a flame; and
directing the diluent into the combustion region to adjust at least one combustion parameter of the flame.

2. The method of claim 1, wherein the combustion parameter of the flame comprises a net heat release, a flame temperature, a flame length, a flame position, a flame volume, a pressure, or any combination thereof.

3. The method of claim 1, wherein directing the diluent into the combustion region comprises surrounding the mixture of the oxidant and the fuel with the diluent.

4. The method of claim 1, wherein an outer wall of the diluent conduit comprises an outermost wall of the fuel nozzle.

5. The method of claim 4, wherein the oxidant conduit surrounds the fuel conduit.

6. The method of claim 1, comprising controlling a flow rate of the diluent based on the at least one combustion parameter of the flame.

7. The method of claim 1, comprising controlling a flow rate of the diluent based on combustion instabilities associated with an operating mode of the gas turbine system.

8. The method of claim 7, wherein the operating mode comprises a start-up mode, a steady-state mode, a transient mode, a partial-load mode, a full-load mode, a full-speed no load mode, or any combination thereof.

9. The method of claim 8, comprising directing a portion of the oxidant or the fuel through the diluent conduit during a first operating mode and directing the diluent through the diluent conduit during a second operating mode of the gas turbine system.

10. A gas turbine system, comprising:
a fuel nozzle, comprising:
a first wall extending along an axis and defining a first fluid passage;
a second wall surrounding the first wall and defining a second fluid passage; and
a third wall surrounding the second wall and defining a third fluid passage, wherein the first and second fluid passages are configured to collectively direct a flow of oxidant and fuel into a combustion region to produce a flame, and the third fluid passage is configured to direct a diluent into the combustion region to adjust a combustion parameter of the flame.

11. The gas turbine system of claim 10, wherein the third wall is an outermost wall of the fuel nozzle.

12. The gas turbine system of claim 10, wherein the fuel nozzle comprises a plurality of premixing tubes extending along the axis and configured to receive and mix the oxidant and the fuel.

13. The gas turbine system of claim 10, wherein the fuel nozzle comprises a plurality of swirl vanes extending from the first wall to the second wall, and each of the plurality of swirl vanes is configured to mix the oxidant and the fuel.

14. The gas turbine system of claim 10, wherein the first, second, and third walls are coaxial with the axis.

15. A gas turbine system, comprising:
a fuel nozzle configured to receive and mix oxidant and a fuel; and
a combustor configured to combust a mixture of the oxidant and the fuel into combustion products, wherein the at least one fuel nozzle comprises:
a first wall extending along an axis and defining a first fluid passage;
a second wall surrounding the first wall and defining a second fluid passage; and
a third wall surrounding the second wall and defining a third fluid passage, wherein the first and second fluid passages are configured to collectively flow the oxidant and the fuel into the combustor to produce a flame, and the third fluid passage is configured to direct a diluent into the combustor and about the oxidant and the fuel to adjust a combustion parameter of the flame.

16. The gas turbine system of claim 15, comprising a fuel supply system, wherein the fuel system comprises:
a primary fuel supply configured to supply a first portion of the fuel to the first or second fluid passage of the at least one fuel nozzle; and
a diluent supply configured to supply the diluent to the third fluid passage of the at least one fuel nozzle.

17. The gas turbine system of claim 16, comprising:
a plurality of control valves configured to adjust a flow rate of the primary fuel, the diluent, or both; and
a controller configured to control the plurality of control valves based on the combustion parameter.

18. The gas turbine system of claim 17, wherein the combustion parameter a net heat release, a flame temperature, a flame length, a flame position, a flame volume, a pressure, or any combination thereof.

19. The gas turbine system of claim 17, wherein the controller is configured to control the plurality of control valves based on combustion instabilities associated with an operating mode of the gas turbine system.

20. The gas turbine system of claim 19, wherein the operating mode comprises a start-up mode, a steady-state mode, a transient mode, a partial-load mode, a full-load mode, a full-speed no load mode, or any combination thereof.
